(19) United States
(12) Patent Application Publication
(10) Pub. No.: US 2021/0264288 A1
(43) Pub. Date: Aug. 26, 2021

(54) PREDICTION MODELING IN SEQUENTIAL FLOW NETWORKS

(71) Applicant: INTERNATIONAL BUSINESS MACHINES CORPORATION, Armonk, NY (US)

(72) Inventors: Pavankumar Murali, Ardsley, NY (US); Haoran Zhu, Madison, WI (US); Dhavalkumar C. Patel, White Plains, NY (US)

(21) Appl. No.: 16/797,394

(22) Filed: Feb. 21, 2020

(51) Int. Cl. G06N 5/00; G06N 20/00

(52) U.S. Cl. CPC G06N 5/003; G06N 20/00

(57) ABSTRACT

Aspects of the invention include a computer-implemented method including receiving, using a processor, a plurality of input process variables and a plurality of output process variables associated with a respective plurality of processes. The processor is used to create an optimal decision tree based on the plurality of input variables, plurality of output variables, and plurality of processes. For each of the plurality of processes, intermediate quality modes and corresponding controls are identified. The optimal decision tree is trained based on the identified intermediate quality modes and corresponding controls. Recommended control variable values are provided for each of the plurality of processes.

### BACKGROUND

The present invention generally relates to process control, and more specifically, to prediction modeling in sequential flow networks.

In many processes, such as oil wells, blast furnaces, or even supply chain management, process control is required. In known process control schemes, inputs, outputs, and process quality are constantly monitored to improve downstream product characteristics. Based on predicted quality at a given time period, optimal control variables for subsequent time periods need to be determined.

### SUMMARY

Embodiments of the present invention are directed to computer-implemented methods for prediction modeling in sequential flow networks. A non-limiting example computer-implemented method includes receiving, using a processor, a plurality of input process variables and a plurality of output process variables associated with a respective plurality of processes. The processor is used to create an optimal decision tree based on the plurality of input variables, plurality of output variables, and plurality of processes. For each of the plurality of processes, intermediate quality modes and corresponding controls are identified. The optimal decision tree is trained based on the identified intermediate quality modes and corresponding controls. Recommended control variable values are provided for each of the plurality of processes.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system level optimal process control model according to embodiments of the present invention;

FIG. 2 depicts a multi-period optimal process control model for a unit process according to embodiments of the invention;

FIG. 3 depicts a flowchart for prediction modeling according to embodiments of the invention;

FIG. 4 depicts an exemplary trained optimal decision tree with an additional layer for handling semi-continuous control variables for prediction modeling according to embodiments of the invention;

FIG. 5 depicts a cloud computing environment according to an embodiment of the present invention;

FIG. 6 depicts abstraction model layers according to an embodiment of the present invention; and

FIG. 7 depicts details of an exemplary computing system capable of implementing aspects of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide for a joint multi-step or multi-time period prediction-optimization framework based on a mixed integer linear programming (“MILP”) based optimization model. Optimal decision trees are used in piecewise linear regression modeling. Set-point control optimization is performed using an optimal decision tree framework. Learning and optimization occur simultaneously in a single formulation.

Process industries often have sequential process flows. For example, crude oil refining and multi-echelon supply chains have sequential flows where quality for each time period needs to be predicted as a function of input control variables in order to identify optimal set-points. Set-points are the target values for a particular output of a flow in the system. For example, pressure in a vessel may need to be controlled at a set-point of 150 pounds per square inch atmosphere in order to get a quality output from the vessel. Control variables for downstream processes need to be determined based on a predicted quality grade of an upstream process.

As another example, for a single process, such as a blast furnace or an oil well, quality of product is continuously monitored. Based on the predicted quality at a given time period, optimal control variables for subsequent time periods need to be determined to optimize quality.

Embodiments of the present invention address one or more shortcomings of the prior art by providing a novel prediction system having interpretability, quality predictions, and tractability. In order to provide interpretability, it is important to improve quality under normal conditions or maintain quality under upstream process failure conditions. Thus, embodiments of the present invention provide a prediction system having the ability to explain or interpret which control variables need to be changed, in what order, and by what quantity. Embodiments of the present invention use decision trees with properties to choose partition and regression variables. To improve prediction quality, optimal decision trees (“ODT”) with an optimization based approach is used to determine branching rules in a multivariate space. In order to provide tractability, tractable optimization formulations and algorithms are implemented to be able to find an integer feasible solution in a quick time period.

Embodiments of the present invention provide a single MILP-based formulation that handles both ODT training and set point optimization. This joint prediction-optimization framework allows simultaneous identification of branching variables, learning of branching rules, and model fitting in leaf nodes; and an optimal order of using control variables for branching and determining optimal values for control variables. The MILP is solved used a decomposition approach. Using this approach, a set-point control optimization model is posed as a sub-problem, and the ODT training is posed as a master problem.

The solution algorithm starts off with training a balanced optimal decision tree. This solution to the master problem is used to solve the set-point control sub-problem. If the learned ODT is either resulting in an unbounded solution or infeasibility, a cut is added to the master problem and resolves. Solving of the MILP and operation of the solution algorithm are performed iteratively until an upper bound and a lower bound of the master problem converge within some error, ∈. In a sub-problem, embodiments of the present invention handle semi-continuous control variables by adding an additional layer to the trained ODT.

Accordingly, embodiments of the invention utilize prediction models that are trained with knowledge of the production operations in order to capture the underlying dynamics of the production process. Embodiments of the invention do not need to make assumptions about linearity of the relationships between outputs and input variables in a model based predictive control setting. Embodiments of the invention do not need to perform offline optimization of set-points based on assumptions of typical steady-state operations.

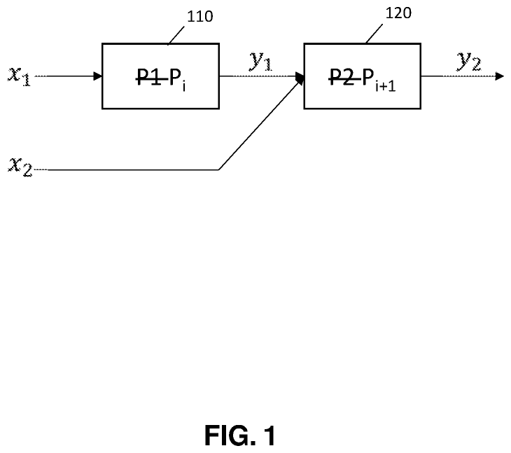

There are two main use cases for set-point optimization for quality control in process industries with sequential flows: system level optimal process control and multi-period optimal process control for a unit process. Turning now to FIG. 1, a system level optimal process control model is generally shown in accordance with one or more embodiments of the present invention. In a sequential process, such as crude oil refining or a multi-echelon supply chain, in each processing stage, yᵢ (ex: quality of or demand for a product) needs to be predicted as a function of xᵢ (control variables) in order to identify optimal set-points. Control variables for downstream processes, xᵢ₊₁, are to be determined based on the predicted quality grade of the upstream process, yᵢ.

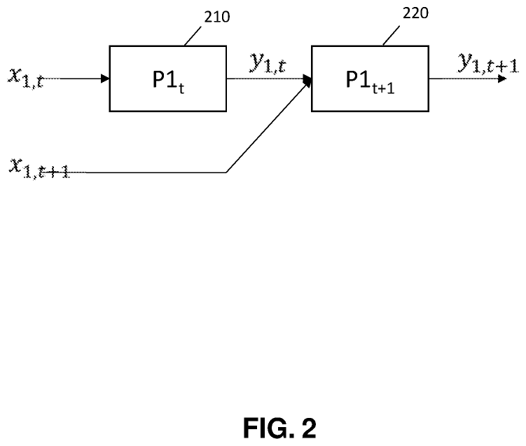

FIG. 2 depicts a multi-period optimal process control model for a unit process according to embodiments of the invention. For a single process, such as a blast furnace or an oil well, quality of product is continually monitored. Based on the predicted quality at a given time period, yₜ, optimal control variables for subsequent time periods, xₜ₊ᵢ, need to be determined to optimize quality.

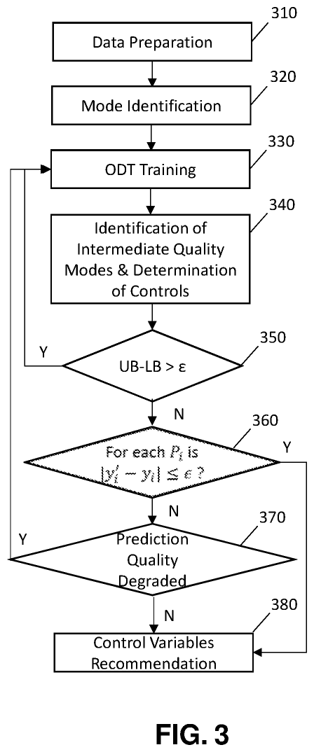

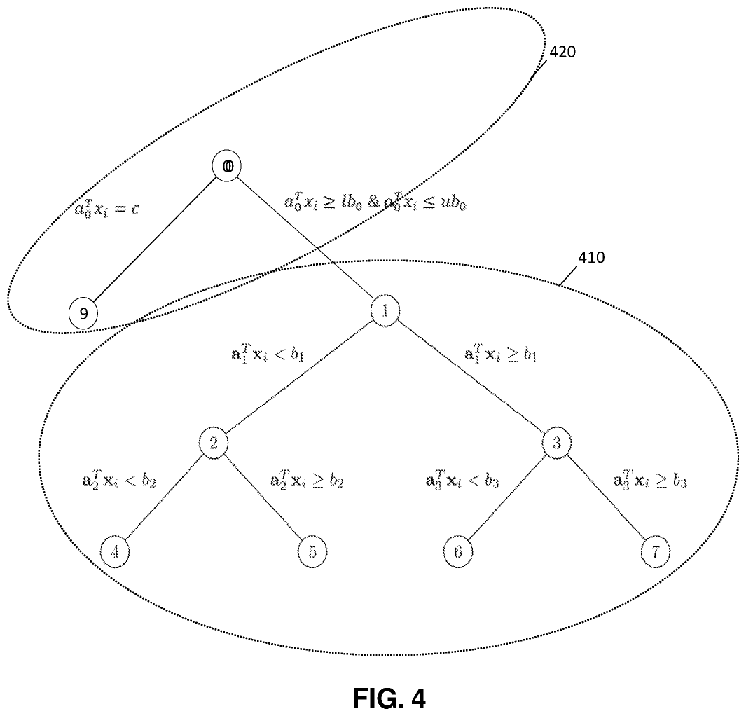

FIG. 3 depicts a flowchart for prediction modeling according to embodiments of the invention. The process receives time series data, which can either be raw or aggregated and with our without time shifts at a data preparation operation. Block 310. The data preparation operation identifies single, self-contained processes with subject matter expert (“SME”) inputs. The data preparation operation will perform feature engineering and extraction, data cleansing, and any data imputation that may be needed. Along with data preparation, a mode identification algorithm identifies the control mode (e.g., open loop, closed loop, on/off, proportional, derivative, integral) from the received time series data. Block 320. Based on the information from the data preparation operation and the mode identification operation, an ODT model is created and trained. Block 330. An exemplary ODT model is shown in FIG. 4 and discussed below.

From the trained ODT model, for processes P₁, . . . , Pₙ, (system level optimal process control) or P_{i,t}, . . . P_{i,T} (multi-period optimal process control for a unit process), the process identifies approximate intermediate quality modes y₁′, . . . , yₙ′ (system level optimal process control) or y_{i,t}′, . . . y_{i,T}′ (multi-period optimal process control for a unit process) determine the corresponding controls using the trained ODT. Block 340. To determine the controls, mixed integer linear programming is used to satisfy the following objectives and constraints. Objectives include: maximizing throughput (Σ_{b=1}^{N}^{_{B}}Σ_{i∈ϕ}_{^{OMax}} f_{i,b}^{O}W_{i,b}^{O}); minimizing inventory changes: (Σ_{b=1}^{N}^{_{B}}Σ_{t∈ϕ}_{^{T}}W_{t,b}d_{t,b}); minimizing deviations from a planned trajectory based on a production plan (Σ_{b=1}^{N}^{_{B}}Σ_{t∈ϕ}_{^{OT}}W_{t,b}^{OT}d_{t,b}^{O}); smoothing decision variables over a planning horizon (Σ_{b=1}^{N}^{_{B}}Σ_{t∈ϕ}_{¹}W_{i,b}¹d_{i,b}¹); penalizing soft margin variables m_{i,b} (Σ_{b}∥h_{b}∥E₂²+α₁,Σ_{i,b}^{m}_{i,b}); and adding a misclassification number into the objective (Σ^{c}ᵢ +Σ_{b}+Σ_{b}∥h_{b}∥₂²+α₁Σ_{i,b}m,_{i, b}+α₂Σ_{b}∥h_{b}∥₀). In the first objective function, i denotes the index of a flow, t₁, t₂ represent intermediate storage tanks, b represents time-period, and I and O represent inflow and outflow respectively.

Further, let f_{i,b}^{I} and f_{i,b}^{O} denote inflow and outflow rates for a unit process i over period b, and v_{t,b,} be the inventory level in tank t at the end of period b. Let N_{B} denote the planning horizon. Φ^{OMax} is the set of unit process outflows and W_{i,b} ^{O} is weight associated with outflow i in period b. In the 2n^{d} objective function, (P^{T} denotes the set of tanks, T_{t,b} is the target level of tank tat the end of period b, d_{t,b}≥0 is the absolute volume deviation variable of tank t in time-period b, and W_{t,b} is the weight associated with volume in tank tin time period b. In the third objective function, ϕ^{OT} is the set of outflows from tanks T, d_{t,b}^{O} is the absolute deviation in the outflows from the tanks w.r.t the production plan, and W_{t,b}^{OT} is the weight associated with outflow from tank t in time bucket b. In the fourth objective function, ϕ^{I} is the deviation in the set of inflow variables, d_{i,b}^{I} is the absolute difference between the flow rate in time-period b and that in b−1 and W_{i,b}^{I} is the weight associated with the absolute difference in the inflow variable i in time period b and that in b−1.

In the optimal decision tree, since the splitting rule at each branching node is given by a single hyperplane, for each leaf node 1, its corresponding region in data space(Rd)is characterized by a polyhedron, with each of its facets (boundaries) given by the branching hyperplane at branch node b. In the fifth objective term, the first quantity is minimizing the L2-norm distance between the data points and the branching hyperplane, and the second quantity minimizes a penalty term, m_{i,b}, associated with the distance between each data point i and branching hyperplane b. Minimizing the misclassification error Σ_{b}∥h_{b∥0}, the 0-norm ∥·∥₀ is counting the number of non-zero components.

Constraints include: setting bounds on decision variables (f_{j,b} ≥F_{i,j}^{min}f_{i,b} & f_{j,b}≤Fᵢⱼ^{max}, f_{i,b}∀b∈1, . . . , N_{B}); setting upper and lower bounds on inventory changes between time periods (v_{t,b}≤v_{t,b-1}+Δ^{U}vₜ^{max} & v_{t,b}, ≥v_{t,b-1}^{-ΔD}v_{t,}^{max} ∀b ∈1, . . . , N_{B}); providing semi-continuous flow constraints (f_{i,b} ^{I}≥Fᵢ^{Min}δ_{i,b}^{IO} and f_{i,b}^{I} ≤Fᵢ^{Max}δ_{i,b}^{IO}); flow conservation (v_{t,b}=v_{t,b-1}+Σ_{i∈ϕ}_{ₜ}_{^{IIT}}f_{i,b}^{I}−Σ_{i∈ϕ}_{ₜ}_{^{IOT}} and f_{i,b}^{I} +Σ_{i∈ϕ}_{ₜ}_{^{OIT}}f_{i,b}^{O}−Σ_{i∈ϕ}_{ₜ}_{^{OOT}}f_{i,b} ^{O}); and regression-tree constraints (f_{i,b}^{O}≤B_{i,l}^{RT}+Σₖ₌₁^{N}^{ᵢ}A_{i,jk,l}^{RT}f_{jk,b}^{I}+M(2−δ_{i,l,b}^{RT}−δ_{i,b}^{Y∅}) & f_{i,b}^{O}≥B_{i,l}^{RT}+Σₖ₌₁^{N}^{ᵢ} A_{i,jk,l}^{RT}f_{jk,b}^{I}−M (2−δ_{i,l,b}^{RT} −δ_{i,b}^{Y∅})). f_{j,b} denotes the flow of product j at time bucket b. The first constraint enforces that the ratio of the flow of product, j, over the flow of product, i, is within a specified range (F_{i,j}^{min}, F_{i,j}^{max}). v_{t,b} denotes the volume in tank at time period b, Δ^{U} and Δ^{D} represent the max increase or decrease allowed in the tank, and vₜ^{max} is the upper bound on the tank volume. The second type of constraint is upper and lower bounds on inventory changes between time periods. For any tank t from period b−1 to period b, volume increase is bounded by Δ^{U}vₜ^{max}. Similarly, for any tank t from period b−1 to period b volume decrease is bounded by Δ^{D}vₜ^{max}. Binary variable δ_{i,b}^{IO} is equal to zero if flow f_{i,b}^{I}=0 and one otherwise. ϕₜ^{IIT} is the set of inflow going into tank t, ϕₜ^{IOT} is the set of inflow going out of tank t, ϕₜ^{OIT}ₜ^{OIT} is the set of outflows going into tank t, and ϕₜ^{OOT} is the set of outflows going out of tank t. Binary variable, δ_{i,l,b}^{kT}, is introduced such that it is equal to one if the regression tree relationship of outflow i is in leaf node l during time-period b and zero otherwise. M is a very large number. A_{i,j,l}^{RT} is the slope of the linear relation between outflow j and inflow j in leaf node l, and B_{i,j}^{RT} is the intercept of the linear relation between outflow j and all inflows in leaf node l. ϕ^{RT} is the set of all outflows with regression tree relationships. Then, it follows that Σₗ₌₁^{l}^{ᵢ} =1∀i ∈ϕ^{RT}, b=1, . . . , N_{B}. binary variable δ_{i,b}^{Y∅}that is zero if all inflows fⱼ_{ₖ}^{I} are zero. δ_{i,b}^{Y∅}is a binary variable that is zero if all inflows fⱼ_{ₖ} ^{I} are zero.

Following identification and determination in Block 340, a test is made to determine if the upper bound of the master problem calculated above minus the lower bound of the master problem calculated above is greater than a threshold, ∈. Block 350). If this is greater than the error, ε, then flow returns to training the ODT model at Block 330. If the upper bound minus the lower bound is less than or equal to an error, ε, then flow continues to Block 360 where a test is made to determine for each Pᵢ is |yᵢ′−yᵢ |≤∈′, where yᵢ is the output of process Pᵢ at an initial iteration and yᵢ′ is the output of process Pᵢ at a following iteration. If not, flow continues to Block 370 where a test is made to determine if the prediction quality for Pᵢ has degraded. If true, flow goes to Block 380 described below.

If prediction quality for Pᵢ has degraded, flow returns to training the ODT model at Block 330. If it has not degraded, flow continues to Block 380 where recommended control variable values for all Pᵢ are provided and an alert is provided if there is a predicted quality deviation beyond an acceptable level.

FIG. 4 depicts an exemplary trained optimal decision tree with an additional layer for handling semi-continuous control variables for prediction modeling according to embodiments of the invention. If semi-continuous control variables are found, an additional layer 420 is added to the trained ODT 410. In this example, a layer with node 0 and node 9 is added above node 1 of the original ODT 410. If α₀^{T}xᵢ=c then the tree is traversed to node 9. If α₀^{T}xᵢ≥lb₀ & α₀^{T}xᵢ ≤ub₀, then the tree is traversed to node 1.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

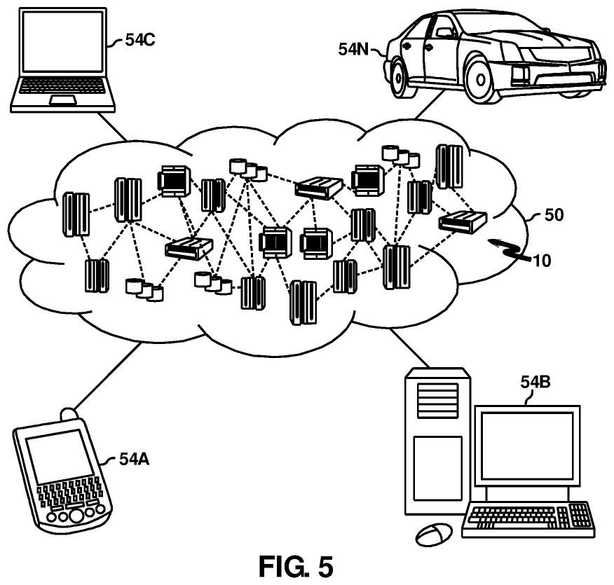

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

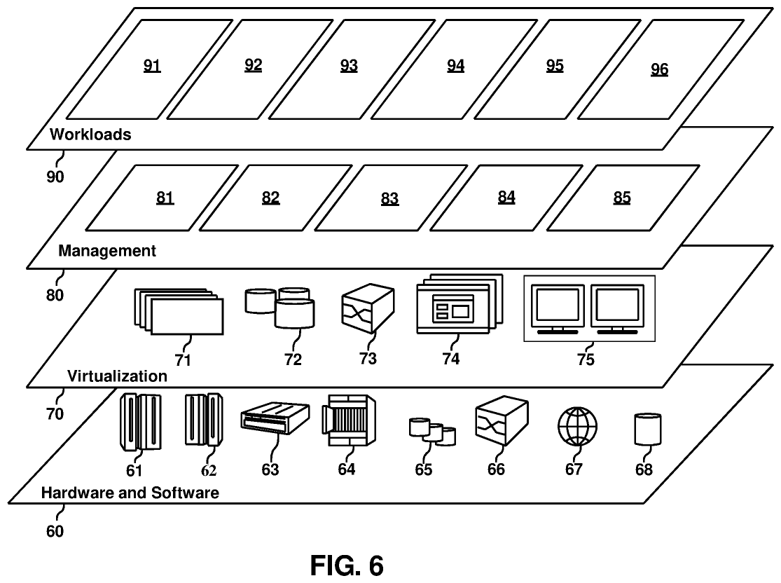

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and interpretable prediction modeling 96.

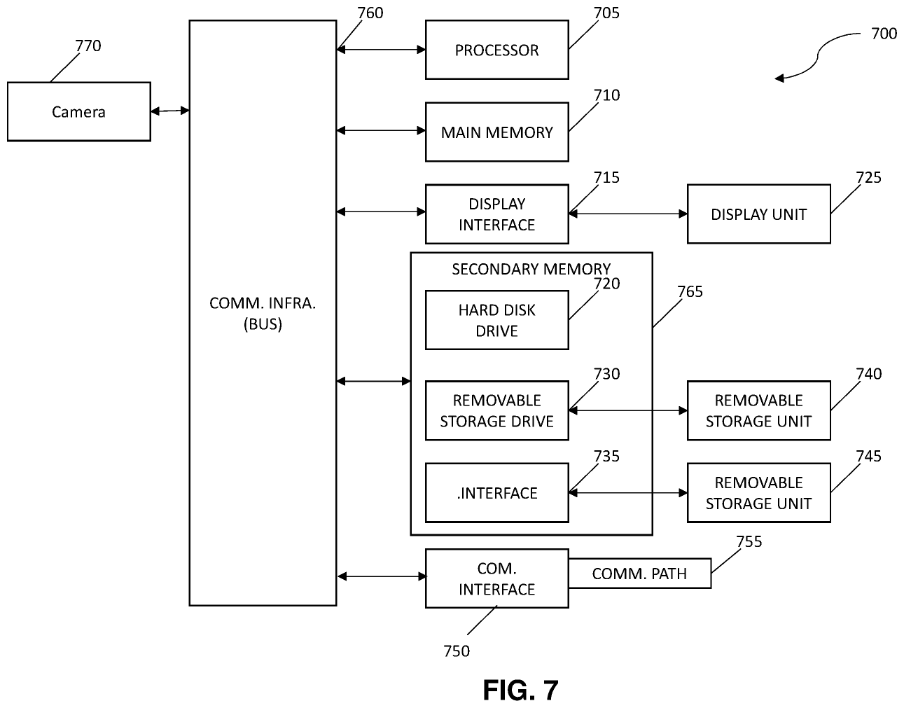

FIG. 7 depicts details of an exemplary computing system capable of implementing aspects of the invention. FIG. 7 depicts a high level block diagram computer system 700, which can be used to implement one or more aspects of the present invention. Computer system 700 may act as a media device and implement the totality of the invention or it may act in concert with other computers and cloud-based systems to implement the invention. More specifically, computer system 700 can be used to implement some hardware components of embodiments of the present invention. Although one exemplary computer system 700 is shown, computer system 700 includes a communication path 755, which connects computer system 700 to additional systems (not depicted) and can include one or more wide area networks (WANs) and/or local area networks (LANs) such as the Internet, intranet(s), and/or wireless communication network(s). Computer system 700 and additional system are in communication via communication path 755, e.g., to communicate data between them.

Computer system 700 includes one or more processors, such as processor 705. Processor 705 is connected to a communication infrastructure 760 (e.g., a communications bus, cross-over bar, or network). Computer system 700 can include a display interface 715 that forwards graphics, text, and other data from communication infrastructure 760 (or from a frame buffer not shown) for display on a display unit 725. Computer system 700 also includes a main memory 710, preferably random access memory (RAM), and can also include a secondary memory 765. Secondary memory 765 can include, for example, a hard disk drive 720 and/or a removable storage drive 730, representing, for example, a floppy disk drive, a magnetic tape drive, or an optical disk drive. Removable storage drive 730 reads from and/or writes to a removable storage unit 740 in a manner well known to those having ordinary skill in the art. Removable storage unit 740 represents, for example, a floppy disk, a compact disc, a magnetic tape, or an optical disk, etc. which is read by and written to by removable storage drive 730. As will be appreciated, removable storage unit 740 includes a computer readable medium having stored therein computer software and/or data.

In alternative embodiments, secondary memory 765 can include other similar means for allowing computer programs or other instructions to be loaded into the computer system. Such means can include, for example, a removable storage unit 745 and an interface 735. Examples of such means can include a program package and package interface (such as that found in video game devices), a removable memory chip (such as an EPROM, or PROM) and associated socket, and other removable storage units 745 and interfaces 735 which allow software and data to be transferred from the removable storage unit 745 to computer system 700. In addition, a camera 770 is in communication with processor 705, main memory 710, and other peripherals and storage through communications interface 760.

Computer system 700 can also include a communications interface 750. Communications interface 750 allows software and data to be transferred between the computer system and external devices. Examples of communications interface 750 can include a modem, a network interface (such as an Ethernet card), a communications port, or a PCM-CIA slot and card, etcetera. Software and data transferred via communications interface 750 are in the form of signals which can be, for example, electronic, electromagnetic, optical, or other signals capable of being received by communications interface 750. These signals are provided to communications interface 750 via communication path (i.e., channel) 755. Communication path 755 carries signals and can be implemented using wire or cable, fiber optics, a phone line, a cellular phone link, an RF link, and/or other communications channels.

In the present description, the terms “computer program medium,” “computer usable medium,” and “computer readable medium” are used to generally refer to media such as main memory 710 and secondary memory 765, removable storage drive 730, and a hard disk installed in hard disk drive 720. Computer programs (also called computer control logic) are stored in main memory 710 and/or secondary memory 765. Computer programs can also be received via communications interface 750. Such computer programs, when run, enable the computer system to perform the features of the present invention as discussed herein. In particular, the computer programs, when run, enable processor 705 to perform the features of the computer system. Accordingly, such computer programs represent controllers of the computer system.

Many of the functional units described in this specification have been labeled as modules. Embodiments of the present invention apply to a wide variety of module implementations. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, comprise the module and achieve the stated purpose for the module.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or obj ect code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptons of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, using a processor, a plurality of input process variables and a plurality of output process variables associated with a respective plurality of processes;
creating, using the processor, an optimal decision tree based on the plurality of input variables, plurality of output variables, and plurality of processes;
for each of the plurality of processes identifying, using the processor, intermediate quality modes and corresponding controls;
training, using the processor, the optimal decision tree based on the identified intermediate quality modes and corresponding controls; and
providing, using the processor, recommended control variable values for each of the plurality of processes.

2. The computer-implemented method of claim 1 further comprising repeating the identification and training steps when an upper bound of an output variable less a lower bound of an output variable is greater than a predetermined error value.

3. The computer-implemented method of claim 1 further comprising halting the repeating of the identification and training steps when an upper bound of an output variable less a lower bound of an output variable is less than or equal to a predetermined error value.

4. The computer-implemented method of claim 1 further comprising for each of the plurality of processes when |yᵢ′−yᵢ|>∈, where yᵢ is the output of a respective process at an initial iteration and y_{i′} is the output of a respective process at a following iteration, checking, using the processor, for degradation of a prediction quality of the respective process.

5. The computer-implemented method of claim 4 further comprising when there is degradation of the prediction quality of the respective process repeating the identification and training steps.

6. The computer-implemented method of claim 1 further comprising cleansing, using the processor, the plurality of input process variables and the plurality of output process variables

7. The computer-implemented method of claim 1 further comprising predicting, using the processor, quality deviations, and alerting, using the processor, a user of the predicted quality deviation.

8. A system comprising:
a memory;
a processor communicatively coupled to the memory, the processor operable to execute instructions stored in the memory, the instructions causing the processor to:
receive a plurality of input process variables and a plurality of output process variables associated with a respective plurality of processes;
create an optimal decision tree based on the plurality of input variables, plurality of output variables, and plurality of processes;
for each of the plurality of processes identify intermediate quality modes and corresponding controls;
train the optimal decision tree based on the identified intermediate quality modes and corresponding controls; and
provide recommended control variable values for each of the plurality of processes.

9. The system of claim 8, wherein instructions further cause the processor to repeat the identification and training steps when an upper bound of an output variable less a lower bound of an output variable is greater than a predetermined error value.

10. The system of claim 8, wherein instructions further cause the processor to halt the repetition of identification and training when an upper bound of an output variable less a lower bound of an output variable is less than or equal to a predetermined error value.

11. The system of claim 8, wherein instructions further cause the processor to, for each of the plurality of processes, when |y′ᵢ−yᵢ|>∈, where yᵢ is the output of a respective process at an initial iteration and y′ᵢ is the output of a respective process at a following iteration, check for degradation of a prediction quality of the respective process.

12. The system of claim 11, wherein instructions further cause the processor to when there is degradation of the prediction quality of the respective process repeat the identification and training steps.

13. The system of claim 8, wherein instructions further cause the processor to cleanse the plurality of input process variables and the plurality of output process variables

14. The system of claim 8, wherein instructions further cause the processor to predict quality deviations, and alert a user of the predicted quality deviation.

15. A computer program product for prediction and optimization in sequential flow networks, the computer program product comprising a computer readable storage medium having program instructions embodied therewith, the program instructions executable by a computer, to cause the computer to perform a method comprising:
receiving, using a processor, a plurality of input process variables and a plurality of output process variables associated with a respective plurality of processes;
creating, using the processor, an optimal decision tree based on the plurality of input variables, plurality of output variables, and plurality of processes;
for each of the plurality of processes identifying, using the processor, intermediate quality modes and corresponding controls;
training, using the processor, the optimal decision tree based on the identified intermediate quality modes and corresponding controls; and
providing, using the processor, recommended control variable values for each of the plurality of processes.

16. The computer program product of claim 15, wherein the method performed by the processor further comprises repeating the identification and training steps when an upper bound of an output variable less a lower bound of an output variable is greater than a predetermined error value.

17. The computer program product of claim 15, wherein the method performed by the processor further comprises halting the repeating of the identification and training steps when an upper bound of an output variable less a lower bound of an output variable is less than or equal to a predetermined error value.

18. The computer program product of claim 15, wherein the method performed by the processor further comprises for each of the plurality of processes when |y′ᵢ−yᵢ|>∈, where yᵢ is the output of a respective process at an initial iteration and y′ᵢ is the output of a respective process at a following iteration, checking, using the processor, for degradation of a prediction quality of the respective process.

19. The computer program product of claim 18, wherein the method performed by the processor further comprises when there is degradation of the prediction quality of the respective process repeating the identification and training steps.

20. The computer program product of claim 15, wherein the method performed by the processor further comprises predicting, using the processor, quality deviations, and alerting, using the processor, a user of the predicted quality deviation.
